(19) United States
(12) Patent Application Publication
(10) Pub. No.: US 2022/0281137 A1
(43) Pub. Date: Sep. 8, 2022

(54) METHOD OF MANUFACTURING PLATE-LIKE MEMBER, INTERMEDIARY BODY OF PLATE-LIKE MEMBER, AND PLATE-LIKE MEMBER

(71) Applicant: NIPPON ELECTRIC GLASS CO., LTD., Otsu-shi, Shiga (JP)

(72) Inventor: Tomomichi KUNIMOTO, Otsu-shi (JP)

(21) Appl. No.: 17/636,623

(22) PCT Filed: Oct. 8, 2020
(86) PCT No.: PCT/JP2020/038127

§ 371 Date: Feb. 18, 2022

(30) Foreign Application Priority Data
Oct. 23, 2019 (JP) 2019-192758

(51) Int. Cl. B28D 5/00; C03B 33/033

(52) U.S. Cl. CPC B28D 5/0011; C03B 33/033

(57) ABSTRACT

Provided is: a method of manufacturing plate-like members and an intermediate body for plate-like members whereby the occurrence of shape defects in the plate-like members can be prevented; and a plate-like member in which shape defects are prevented. The method includes the steps of: providing a first breaking groove 12a in a first principal surface of a base material for plate-like members, the base material having the first principal surface and a second principal surface opposed to each other, and then providing a second breaking groove 13a in the second principal surface of the base material in a direction crossing the first breaking groove 12a in plan view to form an intermediate body 11 for wavelength conversion members (plate-like members); and breaking the intermediate body 11 for wavelength conversion members into separate parts along one of the first breaking groove 12a and the second breaking groove 13a and then breaking the intermediate body 11 for wavelength conversion members into separate parts along the other breaking groove, wherein in breaking the intermediate body 11 for wavelength conversion members into separate parts along the first breaking groove 12a, the intermediate body 11 is broken into separate parts along the first breaking groove 12a by pressing the intermediate body 11 from the second principal surface 11b side, and in breaking the intermediate body 11 for wavelength conversion members into separate parts along the second breaking groove 13a, the intermediate body 11 is broken into separate parts along the second breaking groove 13a by pressing the intermediate body 11 from the first principal surface 11a side.

### TECHNICAL FIELD

The present invention relates to methods of manufacturing plate-like members, intermediate bodies for plate-like members, and plate-like members.

### BACKGROUND ART

Recently, attention has been increasingly focused on light-emitting devices and the like using LEDs or LDs, as next-generation light sources to replace fluorescence lamps and incandescent lamps. As an example of such a next-generation light source, a light-emitting device is disclosed in which an LED capable of emitting a blue light is combined with a wavelength conversion member capable of absorbing part of the light from the LED to convert it to a yellow light. This light-emitting device emits a white light which is a synthesized light of the blue light emitted from the LED and having passed through the wavelength conversion member and the yellow light emitted from the wavelength conversion member.

Patent Literature 1 below describes an example of a light-emitting device using a wavelength conversion member. In obtaining a wavelength conversion member in the production of a light-emitting device, there may be adopted a method of dividing a base material for a wavelength conversion member into parts to obtain a plurality of wavelength conversion members at one time. Patent Literature 1 below describes, as an example of such a dividing process, forming breaking grooves in a grid-like pattern in a base material for wavelength conversion members and then breaking the base material into parts along the breaking grooves. This dividing process is implemented by breaking the base material for wavelength conversion members into separate parts along the breaking grooves extending in one direction (for example, an X direction) of the grid-like pattern and then breaking the separate parts into smaller parts along the breaking grooves extending in the other direction (for example, a Y direction) of the grid-like pattern. The wavelength conversion member obtained by the dividing process is attached to a light source, such as an LED.

### CITATION LIST

### Patent Literature

### [PTL 1]

JP-A-2018-097060

### SUMMARY OF INVENTION

### Technical Problem

In dividing a base material for plate-like members, such as wavelength conversion members, cracks are formed to originate at the breaking grooves and extend in the thickness direction of the base material for plate-like members and, thus, the base material for plate-like members is broken into separate parts. However, cracks may occur which originate at the breaking grooves but extend in directions deviating from the above thickness direction. Therefore, shape defects, such as burrs, may occur in the plate-like members obtained by dividing process.

The present invention aims at providing: a method of manufacturing plate-like members and an intermediate body for plate-like members whereby the occurrence of shape defects in the plate-like members can be prevented; and a plate-like member in which shape defects are prevented.

### Solution to Problem

A method of manufacturing a plate-like member according to the present invention includes the steps of: providing a first breaking groove in a first principal surface of a base material for plate-like members, the base material having the first principal surface and a second principal surface opposed to each other, and then providing a second breaking groove in the second principal surface of the base material for plate-like members in a direction crossing the first breaking groove in plan view to form an intermediate body for plate-like members; and breaking the intermediate body for plate-like members into separate parts along one of the first breaking groove and the second breaking groove and then breaking the intermediate body for plate-like members into separate parts along the other of the first breaking groove and the second breaking groove, wherein in breaking the intermediate body for plate-like members into separate parts along the first breaking groove, the intermediate body for plate-like members is broken into separate parts along the first breaking groove by pressing the intermediate body for plate-like members from the second principal surface side, and in breaking the intermediate body for plate-like members into separate parts along the second breaking groove, the intermediate body for plate-like members is broken into separate parts along the second breaking groove by pressing the intermediate body for plate-like members from the first principal surface side.

A method of manufacturing a plate-like member according to the present invention is a method of manufacturing a plurality of plate-like members by breaking an intermediate body for plate-like members into separate parts, the intermediate body body being provided with a first breaking groove and a second breaking groove, wherein the intermediate body for plate-like members is obtained by providing the first breaking groove in a first principal surface of a base material for plate-like members, the base material having the first principal surface and a second principal surface opposed to each other, and then providing the second breaking groove in the second principal surface of the base material for plate-like members in a direction crossing the first breaking groove in plan view, the method includes the step of breaking the intermediate body for plate-like members into separate parts along one of the first breaking groove and the second breaking groove and then breaking the intermediate body for plate-like members into separate parts along the other of the first breaking groove and the second breaking groove, in breaking the intermediate body for plate-like members into separate parts along the first breaking groove, the intermediate body for plate-like members is broken into separate parts along the first breaking groove by pressing the intermediate body for plate-like members from the second principal surface side, and in breaking the intermediate body for plate-like members into separate parts along the second breaking groove, the intermediate body for plate-like members is broken into separate parts along the second breaking groove by pressing the intermediate body for plate-like members from the first principal surface side.

The first breaking groove and the second breaking groove are preferably orthogonal to each other in plan view.

The plate-like member is preferably a wavelength conversion member. In this case, the wavelength conversion member is preferably formed so that phosphor particles are dispersed in an inorganic matrix.

The plate-like member is preferably a brittle material substrate. In this case, the brittle material substrate is more preferably a glass plate, a glass-ceramic plate or a ceramic plate.

An intermediate body for plate-like members according to the present invention is an intermediate body for plate-like members for use to obtain a plurality of plate-like members by breaking the intermediate body into separate parts, wherein the intermediate body for plate-like members has a first principal surface and a second principal surface opposed to each other, the first principal surface is provided with a first breaking groove, and the second principal surface is provided with a second breaking groove crossing the first breaking groove in plan view.

A plate-like member according to the present invention includes: a first principal surface and a second principal surface opposed to each other; a first side surface and a second side surface connected directly or indirectly to the first principal surface and the second principal surface and opposed to each other; a third side surface and a fourth side surface connected directly or indirectly to the first principal surface and the second principal surface and opposed to each other; a first inclined surface provided to connect between the first principal surface and the first side surface; a second inclined surface provided to connect between the first principal surface and the second side surface; a third inclined surface provided to connect between the second principal surface and the third side surface; and a fourth inclined surface provided to connect between the second principal surface and the fourth side surface.

### Advantageous Effects of Invention

The present invention enables provision of: a method of manufacturing plate-like members and an intermediate body for plate-like members whereby the occurrence of shape defects in the plate-like members can be prevented; and a plate-like member in which shape defects are prevented.

### BRIEF DESCRIPTION OF DRAWINGS

FIG. 1 is a schematic plan view of a plate-like member according to one embodiment of the present invention.

FIG. 2 is a cross-sectional view taken along the line I-I in FIG. 1.

FIG. 3 is a cross-sectional view taken along the line II-II in FIG. 1.

FIG. 4 is a schematic plan view of an intermediate body for plate-like members according to one embodiment of the present invention.

FIGS. 5(a) to 5(c) are schematic frontal cross-sectional views for illustrating a method of manufacturing plate-like members according to one embodiment of the present invention.

FIG. 6 is a schematic, enlarged, frontal cross-sectional view showing a portion of an intermediate body for wavelength conversion members where a first breaking groove is formed, together with the vicinity of the portion, the intermediate body body being used in the method of manufacturing plate-like members according to the one embodiment of the present invention.

FIG. 7 is a schematic cross-sectional view for illustrating the method of manufacturing plate-like members according to the one embodiment of the present invention.

FIGS. 8(a) and 8(b) are schematic frontal cross-sectional views for illustrating division of the intermediate body for plate-like members in the method of manufacturing plate-like members according to the one embodiment of the present invention.

FIGS. 9(a) and 9(b) are schematic frontal cross-sectional views for illustrating the process for switching from one support film to another in the method of manufacturing plate-like members according to the one embodiment of the present invention.

FIGS. 10(a) and 10(b) are schematic frontal cross-sectional views for illustrating division of the intermediate body for plate-like members in the method of manufacturing plate-like members according to the one embodiment of the present invention.

FIG. 11 is a schematic plan view of an intermediate body for plate-like members in a comparative example.

FIG. 12 is a schematic plan view showing a state of the intermediate body for plate-like members in the comparative example immediately after being divided.

FIG. 13 is a schematic plan view showing a state of the intermediate body for plate-like members immediately after being divided in the method of manufacturing plate-like members according to the one embodiment of the present invention shown in FIGS. 5 to 10.

### DESCRIPTION OF EMBODIMENTS

Hereinafter, a description will be given of a preferred embodiment. However, the following embodiment is merely illustrative and the present invention is not limited to the following embodiment. Throughout the drawings, members having substantially the same functions may be referred to by the same reference characters.

[Plate-Like Member]

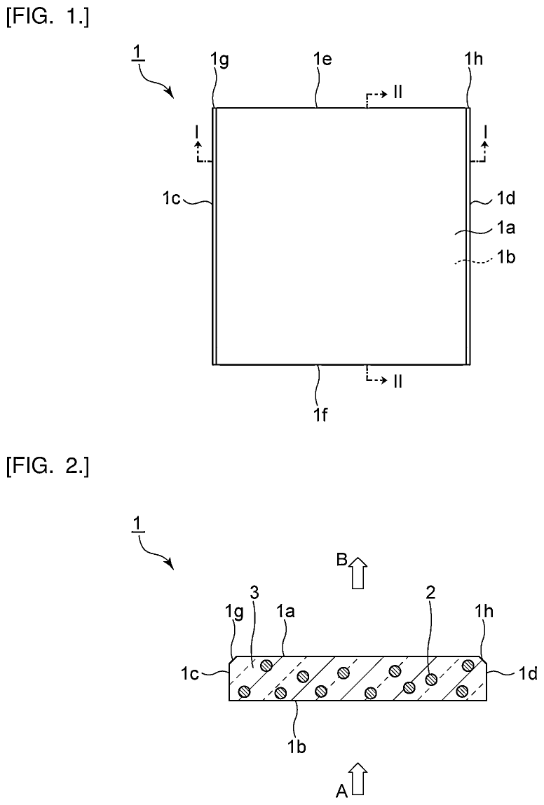

FIG. 1 is a schematic plan view of a plate-like member according to one embodiment of the present invention. A wavelength conversion member 1 is a rectangular plate-like wavelength conversion member 1 having a first principal surface 1a and a second principal surface 1b opposed to each other. The wavelength conversion member 1 has a first side surface 1c and a second side surface 1d opposed to each other and also has a third side surface 1e and a fourth side surface 1f opposed to each other.

FIG. 2 is a cross-sectional view taken along the line I-I in FIG. 1. The wavelength conversion member 1 has a plurality of inclined surfaces at the lateral edges thereof in plan view. Specifically, as shown in FIG. 2, the wavelength conversion member 1 has a first inclined surface 1g and a second inclined surface 1h. The first inclined surface 1g is provided to connect between the first principal surface 1a and the first side surface 1c. The second inclined surface 1h is provided to connect between the first principal surface 1a and the second side surface 1d.

The first principal surface 1a is connected via the first inclined surface 1g indirectly to the first side surface 1c. The first principal surface 1a is connected via the second inclined surface 1h indirectly to the second side surface 1d. On the other hand, the second principal surface 1b is connected directly to the first side surface 1c and the second side surface 1d. The cross-sectional shapes of the first inclined surface 1g and the second inclined surface 1h are linear. However, the cross-sectional shape of at least a portion of the first inclined surface 1g may be a curved shape. The cross-sectional shape of at least a portion of the second inclined surface 1h may also be a curved shape.

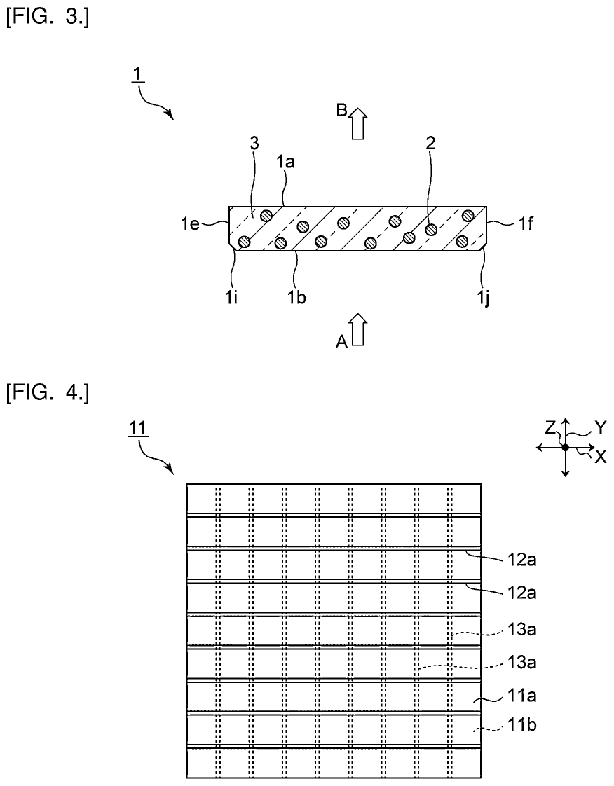

FIG. 3 is a cross-sectional view taken along the line II-II in FIG. 1. As shown in FIG. 3, the wavelength conversion member 1 has a third inclined surface 1i and a fourth inclined surface 1j. The third inclined surface 1i is provided to connect between the second principal surface 1b and the third side surface 1e. The fourth inclined surface 1j is provided to connect between the second principal surface 1b and the fourth side surface 1f.

The second principal surface 1b is connected via the third inclined surface 1i indirectly to the third side surface 1e. The second principal surface 1b is connected via the fourth inclined surface 1j indirectly to the fourth side surface 1f. On the other hand, the first principal surface 1a is connected directly to the third side surface 1e and the fourth side surface 1f. The cross-sectional shapes of the third inclined surface 1i and the fourth inclined surface 1j are linear. However, the cross-sectional shape of at least a portion of the third inclined surface 1i may be a curved shape. The cross-sectional shape of at least a portion of the fourth inclined surface 1j may also be a curved shape.

Herein, the term “plan view” refers to a direction of view from the upper side in FIGS. 2 and 3. As shown in FIG. 2, a portion where the first side surface 1c and the first inclined surface 1g are connected is located, in plan view, laterally of a portion where the first principal surface 1a and the first inclined surface 1g are connected. A portion where the second side surface 1d and the second inclined surface 1h are connected is located laterally of a portion where the first principal surface 1a and the second inclined surface 1h are connected. As shown in FIG. 3, a portion where the third side surface 1e and the third inclined surface 1i are connected is located, in plan view, laterally of a portion where the second principal surface 1b and the third inclined surface 1i are connected. A portion where the fourth side surface 1f and the fourth inclined surface 1j are connected is located, in plan view, laterally of a portion where the second principal surface 1b and the fourth inclined surface 1j are connected.

As shown in FIGS. 2 and 3, the wavelength conversion member 1 is formed so that phosphor particles 2 are dispersed in an inorganic matrix 3. The phosphor particles 2 emit fluorescence upon incidence of excitation light A. Therefore, when excitation light A is incident on the wavelength conversion member 1, a synthesized light B of the excitation light A and the fluorescence is emitted from the wavelength conversion member 1.

The type of the phosphor particles 2 is not particularly limited so long as they can emit fluorescence upon incidence of excitation light A. Specific examples of the type of the phosphor particles 2 include one or more selected from the group consisting of an oxide phosphor, a nitride phosphor, an oxynitride phosphor, a chloride phosphor, an oxychloride phosphor, a sulfide phosphor, an oxysulfide phosphor, a halide phosphor, a chalcogenide phosphor, an aluminate phosphor, a halophosphoric acid chloride phosphor, and a garnet-based compound phosphor. In using a blue light as the excitation light A, for example, a phosphor capable of emitting a green light, a yellow light or a red light as fluorescence can be used.

The average particle diameter of the phosphor particles 2 is preferably 1 μm to 50 μm and more preferably 5 μm to 30 μm. If the average particle diameter of the phosphor particles 2 is too small, the luminescence intensity may decrease. On the other hand, if the average particle diameter of the phosphor particles 2 is too large, the luminescent color may be uneven.

The content of phosphor particles 2 in the wavelength conversion member 1 is preferably not less than 1% by volume, more preferably not less than 1.5% by volume, and still more preferably not less than 2% by volume. The content of phosphor particles 2 in the wavelength conversion member 1 is preferably not more than 70% by volume, more preferably not more than 50% by volume, and still more preferably not more than 30% by volume. If the content of phosphor particles 2 is too small, it is necessary to increase the thickness of the wavelength conversion member 1 in order to obtain a desired luminescent color. This results in increased internal scattering of the resultant wavelength conversion member, which may decrease the light extraction efficiency. On the other hand, if the content of phosphor particles 2 is too large, it is necessary to decrease the thickness of the wavelength conversion member 1 in order to obtain the desired luminescent color, which may decrease the mechanical strength of the wavelength conversion member 1.

No particular limitation is placed on the type of inorganic material for use in the inorganic matrix 3 so long as it can be used as a dispersion medium for the phosphor particles 2, and an example that can be used is glass. Examples of the glass for use in the inorganic matrix 3 include a borosilicate-based glass, a phosphate-based glass, a tin-phosphate-based glass, and a bismuthate-based glass. Examples of the borosilicate-based glass include those containing, in terms of % by mass, 30% to 85% SiO₂, 0% to 30% Al₂O₃, 0% to 50% B₂O₃, 0% to 10% Li₂O+Na₂O+K₂O, and 0% to 50% MgO+CaO+SrO+BaO. Examples of the tin-phosphate-based glass include those containing, in terms of % by mole, 30% to 90% SnO and 1% to 70% P₂O₅.

In this embodiment, the wavelength conversion member 1 as a plate-like member is formed so that the phosphor particles 2 are dispersed in the inorganic matrix 3. However, the wavelength conversion member may be a phosphor ceramic plate. The plate-like member is not limited to the wavelength conversion member. Examples of the plate-like member include, other than the wavelength conversion member, a brittle material substrate made of inorganic material, such as a glass plate, a glass-ceramic plate or a ceramic plate, and a plate-like semiconductor device.

The wavelength conversion member 1 according to this embodiment is obtained by breaking a base material for wavelength conversion members as a base material for plate-like members into separate parts. More specifically, the wavelength conversion member is obtained by breaking an intermediate body for wavelength conversion members, which is formed from the base material for wavelength conversion members and is an intermediate body for plate-like members according to an embodiment of the present invention, into separate parts.

[Intermediate Body for Plate-Like Members]

FIG. 4 is a schematic plan view of an intermediate body for plate-like members according to one embodiment of the present invention. The intermediate body for plate-like members shown in FIG. 4 is used for a method of manufacturing plate-like members according to the present invention. Specifically, the intermediate body for plate-like members shown in FIG. 4 is an intermediate body 11 for wavelength conversion members and is used for the purpose of dividing it into parts to obtain the above-described wavelength conversion member 1.

The intermediate body 11 for wavelength conversion members has a first principal surface 11a and a second principal surface 11b opposed to each other. The intermediate body 11 for wavelength conversion members has a rectangular plate-like shape. However, the shape of the intermediate body 11 for wavelength conversion members is not limited to the rectangular plate-like shape.

The first principal surface 11a of the intermediate body 11 for wavelength conversion members has a plurality of first breaking grooves 12a extending in an X direction. The second principal surface 11b thereof has a plurality of second breaking grooves 13a extending in a Y direction. In this embodiment, the first breaking grooves 12a are orthogonal to the second breaking grooves 13a in plan view. The first breaking grooves 12a may not necessarily be orthogonal to the second breaking grooves 13a in plan view and it is sufficient that the former crosses the latter in plan view. Herein, “extending in the X direction” includes extending substantially in parallel with the X direction without impairing the effects of the invention. Likewise, “extending in the Y direction” includes extending substantially in parallel with the Y direction without impairing the effects of the invention.

In this embodiment, the pattern of the first breaking grooves 12a and the second breaking grooves 13a is formed in a grid-like manner in plan view. However, the pattern of the breaking grooves is not limited to the grid-like manner and a pattern to meet the shape of finally manufactured plate-like members can be appropriately selected.

The depths of the first breaking grooves 12a and the second breaking grooves 13a are not particularly limited, but each of them is preferably in a range of 0.1% to 10% and more preferably in a range of 0.5% to 5% of the thickness of the intermediate body 11 for wavelength conversion members. If the depth of the breaking grooves is too small, breaking along the breaking grooves may be difficult to achieve. If the depth of the breaking grooves is too large, the load for forming the breaking grooves becomes too large, so that cracks may develop in unintended directions, resulting in failure to break the intermediate body into separate parts in a direction perpendicular to the first principal surface 11a.

The width of each of the first breaking grooves 12a and the second breaking grooves 13a is preferably not less than 0.001 mm and more preferably not less than 0.002 mm. On the other hand, the width of each of the first breaking grooves 12a and the second breaking grooves 13a is preferably not more than 0.010 mm and more preferably not more than 0.005 mm. If the width is too large, missing portions may occur during the breaking. If the width is too small, breaking along the breaking grooves may be difficult to achieve.

The intermediate body 11 for wavelength conversion members is formed so that phosphor particles are dispersed in an inorganic matrix. The intermediate body 11 for wavelength conversion members can be made of the same material as the above-described wavelength conversion member 1. However, the intermediate body for plate-like members may be, except for one in which phosphor particles are dispersed in an inorganic matrix, for example, a brittle material substrate made of inorganic material, such as a glass plate, a glass-ceramic plate, a phosphor ceramic plate or a ceramic plate other than the phosphor ceramic plate, or a plate-like semiconductor device.

[Method of Manufacturing Plate-Like Members]

(Step of Forming Intermediate Body for Plate-Like Members)

A description will be given below of an example of a method of manufacturing plate-like members according to one embodiment of the present invention. The plate-like member in this embodiment is the above-described plate-like wavelength conversion member.

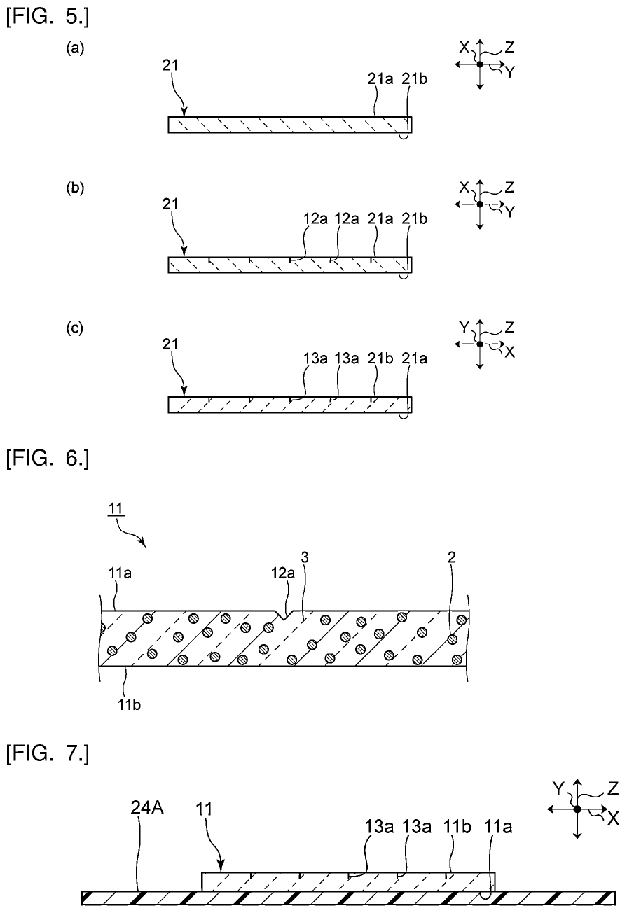

FIGS. 5(a) to 5(c) are schematic frontal cross-sectional views for illustrating a method of manufacturing plate-like members according to one embodiment of the present invention.

First, a rectangular plate-like base material 21 for wavelength conversion members shown in FIG. 5(a) is prepared. The base material 21 for wavelength conversion members has a first principal surface 21a and a second principal surface 21b opposed to each other. The base material 21 for wavelength conversion members is formed so that phosphor particles are dispersed in an inorganic matrix. The base material 21 for wavelength conversion members can be made of the same material as the above-described wavelength conversion member 1. However, the base material for plate-like members may be, except for one in which phosphor particles are dispersed in an inorganic matrix, for example, a brittle material substrate made of inorganic material, such as a glass plate, a glass-ceramic plate, a phosphor ceramic plate or a ceramic plate other than the phosphor ceramic plate, or a plate-like semiconductor device.

Next, as shown in FIG. 5(b), a plurality of first breaking grooves 12a extending in the X direction are provided in the first principal surface 21a of the base material 21 for wavelength conversion members. Next, as shown in FIG. 5(c), a plurality of second breaking grooves 13a extending in the Y direction are provided in the second principal surface 21b. Thus, an intermediate body 11 for wavelength conversion members shown in FIG. 4 can be formed. However, it is sufficient that the second breaking grooves 13a are provided in the second principal surface 21b in a direction where the second breaking grooves 13a cross the first breaking grooves 12a in plan view. The pattern of the breaking grooves to be formed in the base material 21 for wavelength conversion members is not limited to the grid-like manner in plan view and a pattern to meet the shape of finally manufactured plate-like members can be appropriately selected.

FIG. 6 is a schematic, enlarged, frontal cross-sectional view showing a portion of an intermediate body for wavelength conversion members where a first breaking groove is formed, together with the vicinity of the portion, the intermediate body being used in the method of manufacturing plate-like members according to the one embodiment of the present invention. As shown in FIG. 6, the first breaking groove 12a has an approximately V-shaped cross-sectional shape. Specifically, the first breaking groove 12a in this embodiment is formed by abutment of two inclined surfaces having a linear cross-sectional shape. However, the cross-sectional shape of at least a portion of each inclined surface may be a curved shape. Likewise, the second breaking groove 13a schematically shown in FIG. 5(c) also has an approximately V-shaped cross-sectional shape. In this embodiment, the cross-sectional shape of each of inclined surfaces constituting the second breaking groove 13a is linear. However, the cross-sectional shape of at least a portion of each inclined surface of the second breaking groove 13a may be a curved shape.

The first breaking grooves 12a and the second breaking grooves 13a are preferably formed by scribing. A specific method for forming the first breaking grooves 12a and the second breaking grooves 13a can be appropriately selected depending upon the material of the inorganic matrix. If the inorganic matrix is glass, the breaking grooves are preferably formed by a scriber or the like using diamond particles or the like. In the case of use of scribing, for example, it is possible to form the first breaking grooves 12a in the first principal surface 21a of the base material 21 for wavelength conversion members, then turn over the base material 21 for wavelength conversion members, and then form the second breaking grooves 13a in the second principal surface 21b. Alternatively, depending upon the material of the inorganic matrix, the first breaking grooves 12a and the second breaking grooves 13a may be formed by irradiation with laser light.

(Dividing Step)

FIG. 7 is a schematic cross-sectional view for illustrating the method of manufacturing plate-like members according to the one embodiment of the present invention. As shown in FIG. 7, a support film 24A is bonded to the first principal surface 11a of the intermediate body 11 for wavelength conversion members. The support film 24A includes: a support layer; and an adhesive layer provided on the support layer 14a. In this embodiment, the support layer is made of polyolefin film. However, the material for the support layer is not limited to the above and the support layer may be made of any appropriate resin film. Furthermore, in this embodiment, the adhesive layer is made of an ultraviolet curable resin. Examples of the ultraviolet curable resin that can be used include acrylic resins, epoxy resins, and polyurethane resins. However, the material for the adhesive layer is not limited to the above and the adhesive layer may be made of any other resin or so on. In this embodiment, by bonding the adhesive layer of the support film 24A to the first principal surface 11a of the intermediate body 11 for wavelength conversion members, the support film 24A can be bonded to the intermediate body 11 for wavelength conversion members. However, the support film 24A may not necessarily be provided.

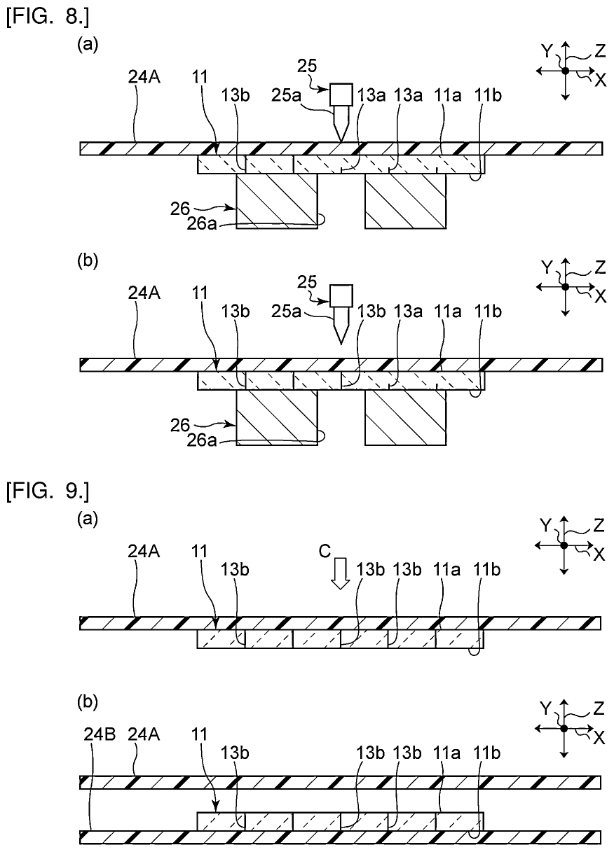

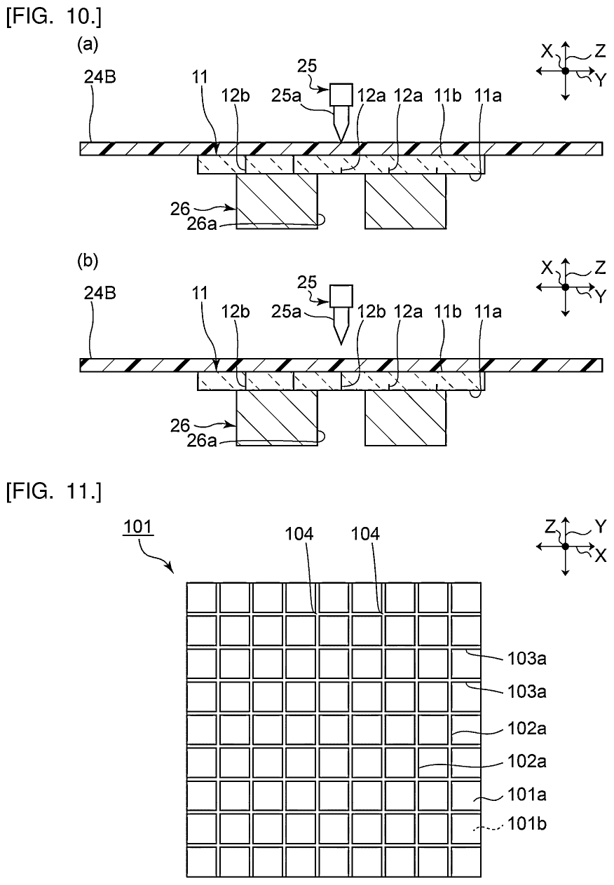

FIGS. 8(a) and 8(b) are schematic frontal cross-sectional views for illustrating division of the intermediate body for plate-like members in the method of manufacturing plate-like members according to the one embodiment of the present invention. FIGS. 9(a) and 9(b) are schematic frontal cross-sectional views for illustrating the process for switching from one support film to another in the method of manufacturing plate-like members according to the one embodiment of the present invention. FIGS. 10(a) and 10(b) are schematic frontal cross-sectional views for illustrating division of the intermediate body for plate-like members in the method of manufacturing plate-like members according to the one embodiment of the present invention.

As shown in FIG. 8(a), in dividing the intermediate body 11 for wavelength conversion members in this embodiment, a pressing member 25 and a support 26 are used. The pressing member 25 includes a blade 25a extending in parallel with the first principal surface 11a of the intermediate body 11 for wavelength conversion members and linearly. On the other hand, the support 26 has a slit 26a.

First, the intermediate body 11 for wavelength conversion members, which is an intermediate body for plate-like members, is divided in the Y direction. Specifically, as shown in FIG. 8(a), the support 26 is placed in contact with the second principal surface 11b of the intermediate body 11 for wavelength conversion members. In doing so, the support 26 is placed so that when viewed from the first principal surface 11a side, a second breaking groove 13a along which breaking is to be done is located within the slit 26a. On the other side of the intermediate body 11, the pressing member 25 is placed at a position opposite the second breaking groove 13a along which breaking is to be done. The position opposite the second breaking groove 13a along which breaking is to be done is, specifically, a position that, in plan view, coincides with the second breaking groove 13a along which breaking is to be done. At this time, each of the blade 25a of the pressing member 25 and the slit 26a of the support 26 extends linearly in the Y direction.

Next, with the support 26 placed as described above, the intermediate body 11 for wavelength conversion members is pressed from the support film 24A side, i.e., from the first principal surface 11a side, by the blade 25a of the pressing member 25. By applying pressure to the intermediate body 11 for wavelength conversion members while being pressed between the support 26 and the pressing member 25 in this manner, a crack originating at the second breaking groove 13a is developed in the thickness direction of the intermediate body 11 for wavelength conversion members as shown in FIG. 8(b). Thus, the intermediate body 11 for wavelength conversion members is broken into separate parts along the second breaking groove 13a. In doing so, a torn surface 13b is formed at a portion of the intermediate body 11 corresponding to the second breaking groove 13a along which breaking has been done. At this time, separate parts of the divided intermediate body 11 for wavelength conversion members are kept bonded to the support film 24A.

Next, the pressing member 25 and the support 26 are moved in the X direction and the intermediate body 11 for wavelength conversion members is broken into separate parts along an adjacent second breaking groove 13a. Alternatively, instead of the pressing member 25 and the support 26, the intermediate body 11 for wavelength conversion members may be moved in the X direction. By repeating the above procedure, the intermediate body 11 for wavelength conversion members is sequentially broken into separate parts along each of a plurality of second breaking grooves 13a arranged spaced apart in the X direction and substantially in parallel with each other and extending in the Y direction. Thus, the intermediate body 11 for wavelength conversion members are broken into a plurality of strip-shaped, separate parts.

Next, as shown in FIG. 9(a), the support film 24A is irradiated with UV light C to cure the adhesive layer of the support film 24A. Specifically, in this embodiment, the support film 24A is irradiated with UV light C from the support layer side. Next, another support film 24B is bonded to the second principal surface 11b of the intermediate body 11 for wavelength conversion members. Next, as shown in FIG. 9(b), the intermediate body 11 for wavelength conversion members is peeled off from the support film 24A.

Next, the intermediate body 11 for wavelength conversion members is divided in the X direction. Specifically, as shown in FIG. 10(a), each of the blade 25a of the pressing member 25 and the slit 26a of the support 26 is placed to extend linearly in the X direction. In dividing the intermediate body 11 for wavelength conversion members in the X direction, the intermediate body 11 for wavelength conversion members is pressed from the support film 24B side, i.e., from the second principal surface 11b side. By applying pressure to the intermediate body 11 for wavelength conversion members while being pressed between the support 26 and the pressing member 25, a crack originating at the first breaking groove 12a is developed in the thickness direction of the intermediate body 11 for wavelength conversion members as shown in FIG. 10(b). Thus, the intermediate body 11 for wavelength conversion members is broken into separate parts along the first breaking groove 12a. In doing so, a torn surface 12b is formed at a portion of the intermediate body 11 corresponding to the first breaking groove 12a along which breaking has been done.

Next, the pressing member 25 and the support 26 are moved in the Y direction and the intermediate body 11 for wavelength conversion members is broken into separate parts along an adjacent first breaking groove 12a. Alternatively, instead of the pressing member 25 and the support 26, the intermediate body 11 for wavelength conversion members may be moved in the Y direction. By repeating the above procedure, the intermediate body 11 for wavelength conversion members is sequentially broken into separate parts along each of a plurality of first breaking grooves 12a arranged spaced apart in the Y direction and substantially in parallel with each other and extending in the X direction. Thus, the intermediate body 11 for wavelength conversion members is divided into a plurality of wavelength conversion members 1.

When the intermediate body 11 for wavelength conversion members is divided, each of the torn surfaces 12b forms a first side surface 1c or a second side surface 1d of a wavelength conversion member 1 shown in FIG. 2. At this time, one of the inclined surfaces having constituted a first breaking groove 12a shown in FIG. 6 forms a first inclined surface 1g and the other forms a second inclined surface 1h.

Likewise, when the intermediate body 11 for wavelength conversion members is divided, each of the torn surfaces 13b shown in FIG. 8(b) forms a third side surface 1e or a fourth side surface 1f of a wavelength conversion member 1 shown in FIG. 3. At this time, one of the inclined surfaces having constituted a second breaking groove 13a forms a third inclined surface 1i and the other forms a fourth inclined surface 1j.

The torn surface 12b formed by breakage along the first breaking groove 12a is linear when viewed from the first principal surface 11a or the second principal surface 11b of the intermediate body 11 for wavelength conversion members. Likewise, the torn surface 13b formed by breakage along the second breaking groove 13a is also linear when viewed from the first principal surface 11a or the second principal surface 11b. The line of earlier formed one of the torn surface 12b and the torn surface 13b as viewed from the first principal surface 11a or the second principal surface 11b is assumed to be a first break line. The line of later formed one of the torn surface 12b and the torn surface 13b as viewed from the first principal surface 11a or the second principal surface 11b is assumed to be a second break line. In this embodiment, the above-described line of the torn surface 13b is the first break line, and the above-described line of the torn surface 12b is the second break line.

Alternatively, it is possible to break the intermediate body 11 for wavelength conversion member into separate parts along the first breaking grooves 12a and then break it into separate parts along the second breaking grooves 13a. In this case, the above-described line of the torn surface 12b is the first break line, and the above-described line of the torn surface 13b is the second break line.

(Details of Effects of Manufacturing Method of Plate-Like Members According to the Present Invention)

This embodiment is characterized by having the following features 1) to 4): 1) The method uses an intermediate body 11 for wavelength conversion members obtained by providing first breaking grooves 12a in the first principal surface 21a of the base material 21 for wavelength conversion members and then providing second breaking grooves 13a in the second principal surface 21b of the base material 21; 2) The method includes the step of breaking the intermediate body 11 for wavelength conversion members into separate parts along either one of the first breaking grooves 12a and the second breaking grooves 13a and then breaking the intermediate body for plate-like members into separate parts along the other; 3) In breaking the intermediate body 11 for wavelength conversion members into separate parts along the first breaking grooves 12a, the intermediate body 11 for wavelength conversion members is broken into separate parts along the first breaking grooves 12a by pressing it from the second principal surface 11b side; and 4) In breaking the intermediate body 11 for wavelength conversion members into separate parts along the second breaking grooves 13a, the intermediate body 11 for wavelength conversion members is broken into separate parts along the second breaking grooves 13a by pressing it from the first principal surface 11a side. Thus, shape defects in the plate-like members can be prevented. The details of this effect will be described below by comparison between this embodiment and a comparative example.

FIG. 11 is a schematic plan view of an intermediate body for plate-like members in a comparative example. As shown in FIG. 11, in an intermediate body 101 for wavelength conversion members as an intermediate body for plate-like members according to a comparative example, a first principal surface 101a is provided with both of first breaking grooves 102a extending in the Y direction and second breaking grooves 103a extending in the X direction. The intermediate body 101 for wavelength conversion members has, on the first principal surface 101a, intersection points 104 of the first breaking grooves 102a with the second breaking grooves 103a. In dividing the intermediate body 101 for wavelength conversion members, the intermediate body 101 for wavelength conversion members is broken into separate parts along all the first breaking grooves 102a and then broken into separate parts along all the second breaking grooves 103a. Thus, wavelength conversion members 111 are obtained.

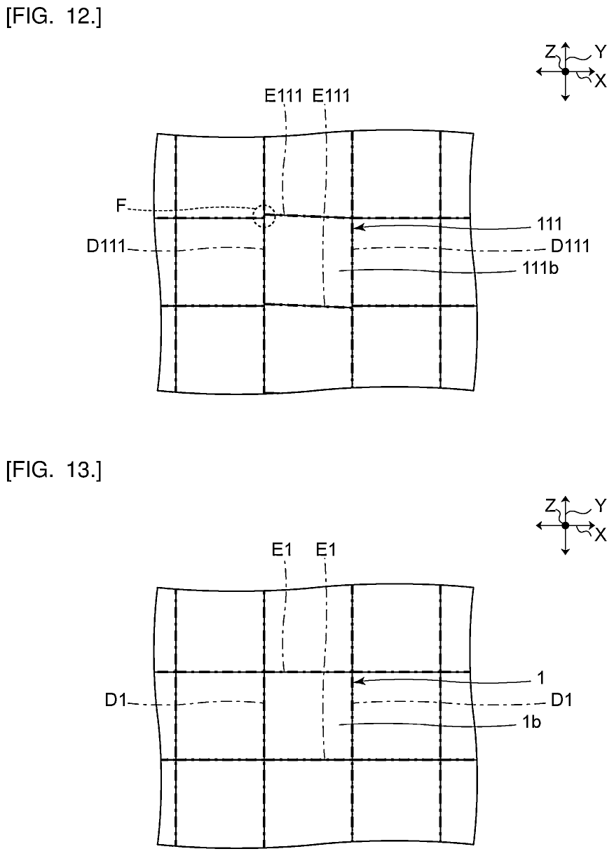

FIG. 12 is a schematic plan view showing a state of the intermediate body for plate-like members in the comparative example immediately after being divided. FIG. 13 is a schematic plan view showing a state of the intermediate body for plate-like members immediately after being divided in the method of manufacturing plate-like members according to the one embodiment of the present invention shown in FIGS. 5 to 10. FIGS. 12 and 13 are views when viewed from the second principal surface 101b of the wavelength conversion members or the second principal surface 1b of the wavelength conversion members.

As shown in FIG. 12, in the comparative example, first break lines D111 extend in parallel with the Y direction. However, portions of second break lines E111 extend at an angle to the X direction. More specifically, for example, as shown by the dashed line F, the second break line E111 has a step at an intersection with the first break line D111. A displacement due to this step is, for example, over 10 μm. Therefore, the second principal surfaces 111b of some wavelength conversion members 111 do not take a perfect rectangular shape. As just described, in the comparative example, shape defects are likely to occur in breaking the intermediate body 101 for wavelength conversion members into separate parts along the second breaking grooves 103a shown in FIG. 11.

Unlike the above, in the dividing process in the above embodiment as shown in FIG. 13, the first break lines D1 extend in parallel with the Y direction and the second break lines E1 extend in parallel with the X direction. Therefore, the second principal surfaces 1b of all the wavelength conversion members 1 shown in FIG. 13 have a rectangular shape. As just described, in the embodiment according to the present invention, shape defects of the wavelength conversion members 1 are less likely to occur. The reason for this can be attributed as follows.

When the intermediate body 101 for wavelength conversion members in the comparative example shown in FIG. 11 is broken into separate parts along the first breaking grooves 102a, lateral cracks may occur, around the intersection points 104, in the X direction where the second breaking grooves 103a extend. When the intermediate body 101 for wavelength conversion members is subsequently divided into separate parts along the second breaking grooves 103a, cracks easily develop, around the intersection points 104 where the lateral cracks have occurred, to the second principal surfaces 101b earlier than the other portions. Since, as just described, a difference is made in timing of crack development between around the intersection points 104 and the other portions, cracks may develop in a direction deviating from the thickness direction of the intermediate body 101 for wavelength conversion members.

Therefore, in the comparative example, shape defects of the wavelength conversion members 111 are likely to occur.

Unlike the above, in the intermediate body 11 for wavelength conversion members according to the above embodiment of the present invention, the first principal surface 11a is provided with the first breaking grooves 12a and the second principal surface 11b is provided with the second breaking grooves 13a. Thus, in forming the intermediate body 11 for wavelength conversion members, lateral cracks that would occur due to provision of the first breaking grooves 12a and the second breaking grooves 13a in the same principal surface do not occur. Therefore, a difference in timing of crack development that may occur in the comparative example is less likely to occur, so that crack development in the direction deviating from the thickness direction of the intermediate body 11 for wavelength conversion members can be prevented. Hence, in the above embodiment of the present invention, shape defects of wavelength conversion members 1 as plate-like members can be prevented.

In addition, the first principal surface 11a provided with the first breaking grooves 12a is a principal surface to which pressure is to be applied in breaking the intermediate body 11 for wavelength conversion members into separate parts along the second breaking grooves 13a. Therefore, in breaking the intermediate body 11 into separate parts along the second breaking grooves 13a, a compressive stress, not a tensile stress, is applied around the first breaking grooves 12a. Thus, it can be certainly prevented that cracks originating at the first breaking grooves 12a occur before the step of breaking the intermediate body 11 for wavelength conversion members into separate parts along the first breaking grooves 12a. Hence, crack development in the direction deviating from the thickness direction of the intermediate body 11 for wavelength conversion members can be more certainly prevented, so that shape defects of the wavelength conversion members 1 can be further prevented.

In the comparative example, shape defects are likely to occur when the break line pitch is relatively small (for example, less than 1 mm). Therefore, the method according to the present invention is particularly effective when the break line pitch is small as in the above case.

### REFERENCE SIGNS LIST

1 . . . wavelength conversion member
1a . . . first principal surface
1b . . . second principal surface
1c . . . first side surface
1d . . . second side surface
1e . . . third side surface
1f . . . fourth side surface
1g . . . first inclined surface
1h . . . second inclined surface
1i . . . third inclined surface
1j . . . fourth inclined surface
2 . . . phosphor particle
3 . . . inorganic matrix
11 . . . intermediate body for wavelength conversion members
11a . . . first principal surface
11b . . . second principal surface
12a . . . first breaking groove
12b . . . torn surface
13a . . . second breaking groove
13b . . . torn surface
21 . . . base material for wavelength conversion members
21a . . . first principal surface
21b . . . second principal surface
24A . . . support film
24B . . . support film
25 . . . pressing member
25a . . . blade
26 . . . support
26a . . . slit
101 . . . intermediate body for wavelength conversion members
101a . . . first principal surface
102a . . . first breaking groove
103a . . . second breaking groove
104 . . . intersection point
111 . . . wavelength conversion member
111b . . . second principal surface
D1 . . . first break line
D111 . . . first break line
E1 . . . second break line
E111 . . . second break line

1: A method of manufacturing a plate-like member, the method comprising the steps of:
providing a first breaking groove in a first principal surface of a base material for plate-like members, the base material having the first principal surface and a second principal surface opposed to each other, and then providing a second breaking groove in the second principal surface of the base material for plate-like members in a direction crossing the first breaking groove in plan view to form an intermediate body for plate-like members; and
breaking the intermediate body for plate-like members into separate parts along one of the first breaking groove and the second breaking groove and then breaking the intermediate body for plate-like members into separate parts along the other of the first breaking groove and the second breaking groove,
wherein in breaking the intermediate body for plate-like members into separate parts along the first breaking groove, the intermediate body for plate-like members is broken into separate parts along the first breaking groove by pressing the intermediate body for plate-like members from the second principal surface side, and
in breaking the intermediate body for plate-like members into separate parts along the second breaking groove, the intermediate body for plate-like members is broken into separate parts along the second breaking groove by pressing the intermediate body for plate-like members from the first principal surface side.

2: A method of manufacturing a plurality of plate-like members by breaking an intermediate body for plate-like members into separate parts, the intermediate body being provided with a first breaking groove and a second breaking groove, wherein
the intermediate body for plate-like members is obtained by providing the first breaking groove in a first principal surface of a base material for plate-like members, the base material having the first principal surface and a second principal surface opposed to each other, and then providing the second breaking groove in the second principal surface of the base material for plate-like members in a direction crossing the first breaking groove in plan view,
the method comprises the step of breaking the intermediate body for plate-like members into separate parts along one of the first breaking groove and the second breaking groove and then breaking the intermediate body for plate-like members into separate parts along the other of the first breaking groove and the second breaking groove,
in breaking the intermediate body for plate-like members into separate parts along the first breaking groove, the intermediate body for plate-like members is broken into separate parts along the first breaking groove by pressing the intermediate body for plate-like members from the second principal surface side, and
in breaking the intermediate body for plate-like members into separate parts along the second breaking groove, the intermediate body for plate-like members is broken into separate parts along the second breaking groove by pressing the intermediate body for plate-like members from the first principal surface side.

3: The method of manufacturing plate-like members according to claim 1, wherein the first breaking groove and the second breaking groove are orthogonal to each other in plan view.

4: The method of manufacturing plate-like members according to claim 1, wherein the plate-like member is a wavelength conversion member.

5: The method of manufacturing plate-like members according to claim 4, wherein the wavelength conversion member is formed so that phosphor particles are dispersed in an inorganic matrix.

6: The method of manufacturing plate-like members according to claim 1, wherein the plate-like member is a brittle material substrate.

7: The method of manufacturing plate-like members according to claim 6, wherein the brittle material substrate is a glass plate, a glass-ceramic plate or a ceramic plate.

8: An intermediate body for plate-like members for use to obtain a plurality of plate-like members by breaking the intermediate body into separate parts, wherein
the intermediate body for plate-like members has a first principal surface and a second principal surface opposed to each other,
the first principal surface is provided with a first breaking groove, and
the second principal surface is provided with a second breaking groove crossing the first breaking groove in plan view.

9: A plate-like member comprising:
a first principal surface and a second principal surface opposed to each other;
a first side surface and a second side surface connected directly or indirectly to the first principal surface and the second principal surface and opposed to each other;
a third side surface and a fourth side surface connected directly or indirectly to the first principal surface and the second principal surface and opposed to each other;
a first inclined surface provided to connect between the first principal surface and the first side surface;
a second inclined surface provided to connect between the first principal surface and the second side surface;
a third inclined surface provided to connect between the second principal surface and the third side surface; and
a fourth inclined surface provided to connect between the second principal surface and the fourth side surface.
